(19) United States
(12) Patent Application Publication
(10) Pub. No.: US 2025/0190254 A1
(43) Pub. Date: Jun. 12, 2025

(54) DETECTING LATENCY THROUGH INDEX INGESTION PIPELINE TO IMPROVE SEARCH

(71) Applicant: Microsoft Technology Licensing, LLC, Redmond, WA (US)

(72) Inventors: Christoffer Benjamin ROSEN, Seattle, WA (US); Christina Juliet STANLEY, Snoqualmie, WA (US); Sarosh ANWAR, Redmond, WA (US); Jae Dong HWANG, Kirkland, WA (US); Thottam R. SRIRAM, Redmond, WA (US); Mengdong YANG, Sammamish, WA (US)

(21) Appl. No.: 18/533,818

(22) Filed: Dec. 8, 2023

(51) Int. Cl. G06F 9/50; G06F 9/54; G06F 11/34

(52) U.S. Cl. CPC G06F 9/5005; G06F 9/542; G06F 11/3419

(57) ABSTRACT

When a content modification is detected, a set of properties corresponding to that content modification is identified, and a timestamp is generated indicating when the content modification was made. An index request including the properties and timestamp are provided to an index ingestion pipeline. Each component in the index ingestion pipeline generates a separate timestamp indicating when the index request was received at the corresponding component. The timestamps generated by each of the components in the index ingestion pipeline are sent through the index ingestion pipeline, along with the properties, to an output component which outputs an index entry that can be stored in a search index. The output component also generates an index latency output that can be provided to a latency processing system. The index latency output indicates the latency introduced by each of the components in the index ingestion pipeline, and also identifies the properties of the content modification. An action signal is generated based upon the index latency output.

### BACKGROUND

Computing systems are currently in wide use. Many computing systems include content systems that are hosted and made accessible to one or more different tenants, where each tenant may be an organization. In such systems, it is not uncommon for the content system to be accessible to users of a tenant so that the users can generate additional content, make changes to existing content, etc.

In such content systems, the users corresponding to a tenant or organization may wish to search for content within that organization. Therefore, it is also not uncommon for organizations to use a search system which generates a search index based on content that is mastered in the content system. For instance, as new content is created or modified, that creation or modification is detected and, if the content is sharable to different users in the tenant organization, then the changes to the content or the generation of new content can be indexed in a search index so the change or new content can be located using a search system.

In order to index an item of content, an index request can be provided to an index ingestion pipeline. The index ingestion pipeline may have a plurality of different components that perform different operations in order to generate an index entry that represents the detected new content or modified content. Once the index request is processed through the index ingestion pipeline, an index entry is generated and stored in a search index which can be accessed by a search system. Therefore, when users at the tenant organization wish to search for content, the users can generate queries through the search system to locate the desired content using the search index.

The discussion above is merely provided for general background information and is not intended to be used as an aid in determining the scope of the claimed subject matter.

### SUMMARY

When a content modification is detected, a set of properties corresponding to that content modification is identified, and a timestamp is generated indicating when the content modification was made. An index request including the properties and timestamp are provided to an index ingestion pipeline. Each component in the index ingestion pipeline generates a separate timestamp indicating when the index request was received at the corresponding component. The timestamps generated by each of the components in the index ingestion pipeline are sent through the index ingestion pipeline, along with the properties, to an output component which outputs an index entry that can be stored in a search index. The output component also generates an index latency output that can be provided to a latency processing system. The index latency output indicates the latency introduced by each of the components in the index ingestion pipeline, and also identifies the properties of the content modification. An action signal is generated based upon the index latency output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 2A and 2B (collectively referred to herein as FIG. 2) illustrate a block diagram showing the computing system architecture illustrated in FIG. 1 in more detail.

FIG. 3 shows one example of an aggregated indexing latency output.

FIGS. 4A and 4B (collectively referred to herein as FIG. 4) show a flow diagram illustrating one example of the operation of the computing system architecture illustrated in the previous figures.

FIG. 5 is a block diagram showing one example of the computing system architecture deployed in a remote server architecture.

FIG. 6 is a block diagram showing one example of a computing environment that can be used in the architectures and systems described in previous figures.

### DETAILED DESCRIPTION

As discussed above, some computing systems include a content system and a search system. The content system can be used by users to generate modifications to content. Similarly, the content system can be used by workflows to generate workflow-initiated modifications as well. The content and the modifications to the content can be searchable through a search system that has a search index that is separate from the content system. It may be desirable to know how quickly a content modification is represented by an index entry in the search index. For instance, until a modification is represented by an index entry in the search index, it is difficult for users to use the search system to locate that content modification. This can greatly affect the precision and recall performance of the search system. For instance, when a user generates and publishes a new document or other item of content in the content system, the user may desire that other users be able to locate that item of content, through the search system, very quickly. Similarly, where permissions are changed on a document or other item of content, it may be desirable for those permissions to be reflected in the search index very quickly as well.

In order for an item to be represented in the search index, an index request is generated at the content system based upon a detected modification to the content. That index request is then provided to an index ingestion pipeline that may have a plurality of different components. Each component in the index ingestion pipeline may perform a different set of operations relative to the index request in order to generate the index entry corresponding to the detected content modification. The different components may be managed by different teams or different organizations making it difficult to determine the indexing latency introduced by each component.

Some types of systems which may attempt to identify the latency through the index ingestion pipeline may include logging. For instance, each component may be requested to log a latency value corresponding to each index request, based upon a common index request identifier. However, this can be problematic in that, in order to obtain the latency data for a single index request, the system must join the individual logs using the common request identifier. However, joining logs across perhaps millions or billions of index requests can be very difficult. Similarly, problems with this type of logging are encountered based upon differences in log sampling rates among the different components in the index ingestion pipeline as well as potential delays that may be encountered in the component queues for each of the different components.

In addition, not all operations that modify the content in the content system are of equal importance to a user or another system. Therefore, the precision and recall performance of the search system need not be the same for all content modifications. For instance, as discussed above, when a user publishes a document within the content system and then fails to find that document in search results when searching for the document using the search system, this may negatively affect the user's search experience. However, when the modification is simply updating metadata on a content document in the content system, then even if there is a delay in making those metadata modifications searchable, this may not have a significant impact on the perceived recall and precision performance of the search system.

In addition, there may be scenarios, such as customer migrations, where a large number of documents or other content items are simultaneously pushed through the index ingestion pipeline. In these types of scenarios, users may expect some delay before all items appear in the search index. Thus, even if the latency through the index ingestion pipeline is tracked, this information may be even more useful with additional information, such as what type of operation in the content system initiated the indexing operation, etc.

Therefore, the present description proceeds with respect to a system that identifies when a modification is made in a content system and generates an index request based on the detected modifications. The present description proceeds with respect to a system that generates a timestamp indicating when the modification was made and when the index request lands at each indexing component in the index ingestion pipeline. In one example, the present system also collects a set of properties corresponding to the operation that caused the modification. Those properties (which are discussed in greater detail below) may identify things such as the type of operation so that the latency corresponding to operations that strongly impact the precision and/or recall performance of the search system can be independently identified. The timestamps are passed, through the index ingestion pipeline, along with the properties corresponding to the index request. Therefore, when the final component in the index ingestion pipeline (which outputs the index entry to the search index) is finished processing the index request, that final component can generate an aggregated indexing latency output which identifies the properties of the operation that caused modification to the content, the indexing priority of that operation, and a timestamp corresponding to each of the components in the index ingestion pipeline. Thus, the latency introduced by each component can be identified.

An action trigger can be generated based upon the aggregated indexing latency output, such as to generate an alert when a component is outside a desired latency threshold, for example, to automatically reconfigure a component to improve its latency, to generate suggested reconfigurations or modifications to the different components that have an undesirably large latency, to generate a dashboard or other interactive display that can be analyzed by engineers or developers in order to identify components in the index ingestion pipeline that have undesirably large latencies and to improve the operation of those components to reduce the latency, among other things. Thus, the present description proceeds with respect to a system that greatly enhances the recall and/or precision performance of a search system by detecting and surfacing the latency corresponding to each component in the index ingestion pipeline.

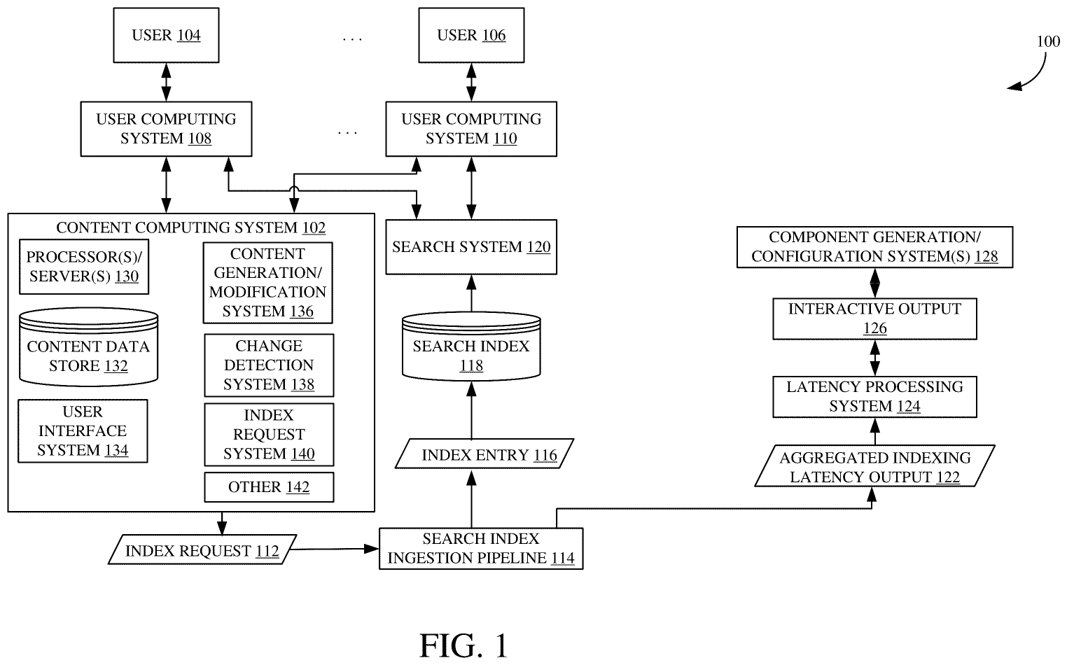

FIG. 1 is a block diagram of one example of a computing system architecture 100. In one example, architecture 100 includes a content computing system 102 that can be accessed by users 104-106 who may use user computing systems 108-110.

Search index ingestion pipeline 114 processes the index request 112 to generate an index entry 116 for storage in a search index 118. Users 104-106 can search for the content or modifications generated in content computing system 102 using a search system 120 that accesses search index 118. Thus, when modifications to content are made in content computing system 102, those modifications are detected and an index request 112 is generated to index those modifications so that the modifications can be accessed by users 104-106 through search system 120.

Once index entry 116 is entered in search index 118, users 104-106 can search for the content or content modifications represented by that index entry 116 using search system 120. For instance, search system 120 may generate user interfaces that allow users 104-106 to enter search queries or other information that can be used by search system 120 to search the search index 118 based upon those queries. Search system 120 can then provide search results back to the requesting user.

As discussed in greater detail below, search index ingestion pipeline 114 may include a plurality of different components that perform different index processing operations based on index request 112 in order to generate index entry 116. Search index ingestion pipeline 114 also generates an aggregated indexing latency output 122 that identifies the latency corresponding to each of the components in search index ingestion pipeline 114, as well as other information (also discussed below). Latency processing system 124 can perform processing on the aggregated indexing latency output 122 to generate an interactive output 126 that can be provided to component generation/configuration systems 128. Based upon the interactive output 126, engineers, developers, and/or other users can reconfigure or modify the components in search index ingestion pipeline 114 to reduce the latency corresponding to those components or to perform other operations.

Computing system 102 may include one or more processors or servers 130, data store 132, user interface system 134, content generation/modification system 136, change detection system 138, index request system 140, and other items 142. Content data store 132 can store content items (such as documents or other content items) that can be accessed by users 104-106 through user interface system 134. User interface system 134 may generate user interfaces that users 104-106 can interact with in order to modify (e.g., generate, revise, delete, or perform other operations on) content data in content data store 132. Content generation/modification system 136 may include applications or other content generation or modification systems that allow users 104-106 to access and manipulate the content in content data store 132. Change detection system 138 can detect changes or modifications to the content and provide an output to index request system 140 indicative of those changes or modifications. Index request system 140 can detect or generate a timestamp indicating when the modifications were made, and identify a plurality of different properties corresponding to the operation that made the content modification. Based on such information, index request system 140 generates index request 112 and provides index request 112 to search index ingestion pipeline 114.

As discussed above, the precision and recall performance of search system 120 may be negatively affected if the content modifications are not indexed into search index 118 quickly enough. Therefore, the latency introduced by the different components in the search index ingestion pipeline 114 is information that may be helpful in reconfiguring or otherwise developing the components in search index ingestion pipeline 114 in order to reduce latency. However, the different components in search index ingestion pipeline 114 are often owned by different teams or organizations so it can be difficult to identify the latency corresponding to each component. Therefore, search index ingestion pipeline 114 generates a timestamp corresponding to each component and transmits that timestamp along with the properties in index request 112 to subsequent components in the search index ingestion pipeline 114. The timestamp information and properties can then be output by the final component in index ingestion pipeline 114 as aggregated indexing latency output 122 for access by latency processing system 124.

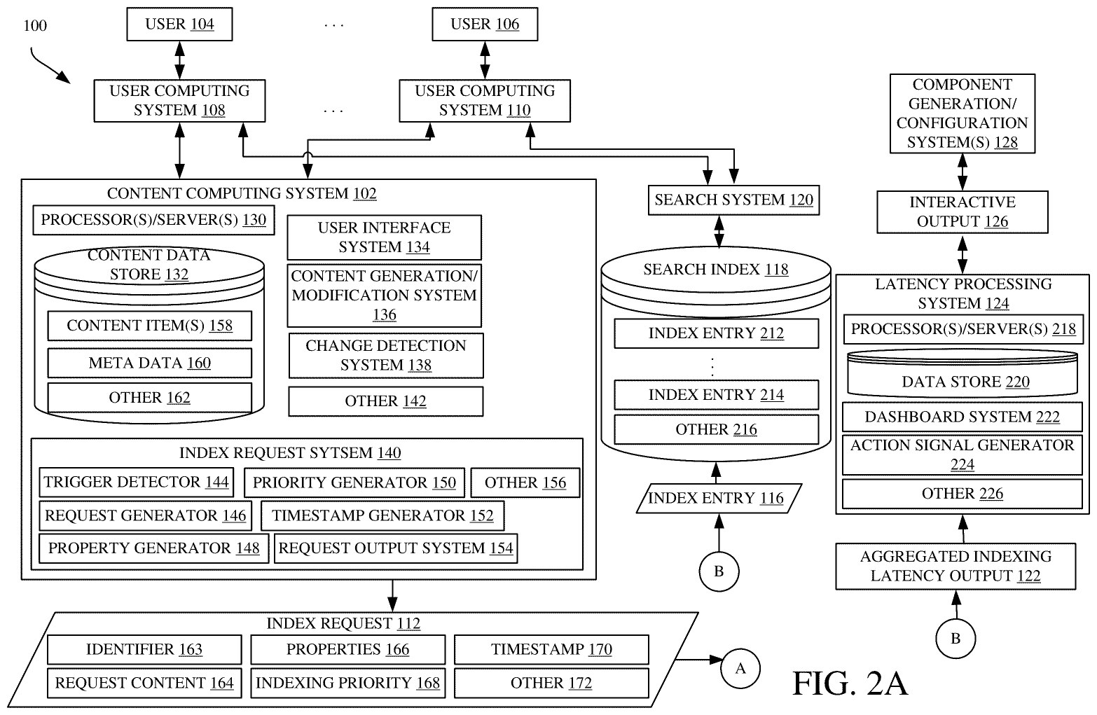

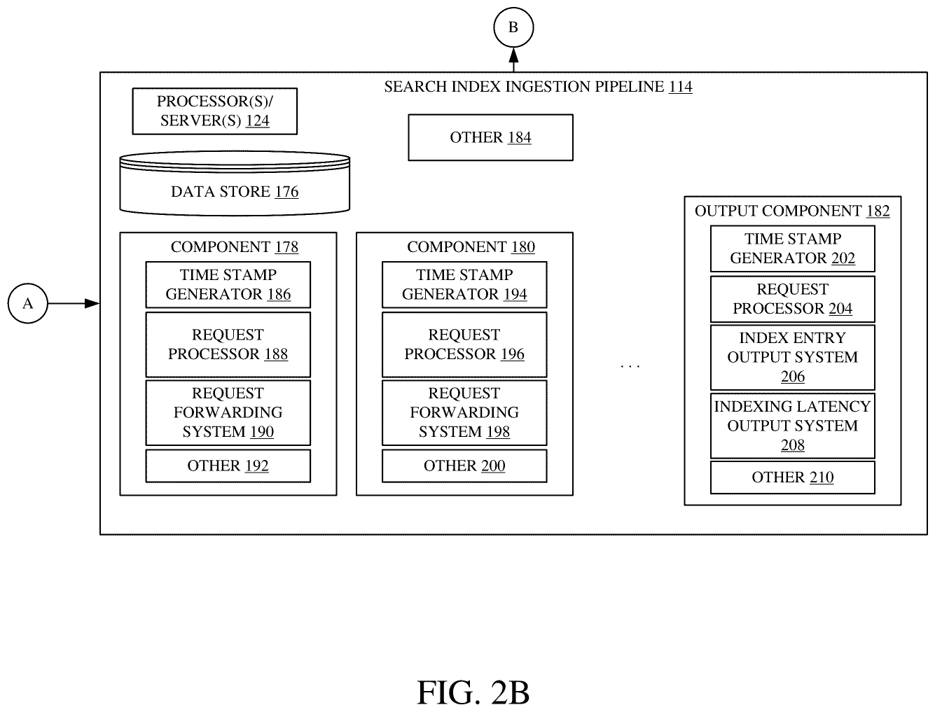

FIGS. 2A and 2B (collectively referred to herein as FIG. 2) are block diagrams showing one example of the computing system architecture 100 in more detail. Some of the items shown in FIG. 2 are similar to those shown in FIG. 1, and they are similarly numbered. In the example shown in FIG. 2, index request system 140 includes trigger detector 144, request generator 146, property generator 148, priority generator 150, timestamp generator 152, request output system 154, and other items 156. Data content store 132 can include a plurality of different content items 158, corresponding metadata 160, and other items 162.

Index request 112 can include request identifier 163, request content 164, properties 166, priority 168, timestamp 170, and other items 172. Search index ingestion pipeline 114 can include one or more processors or servers 174, data store 176, and a plurality of components 178, 180, 182, and any of a wide variety of other items 184. FIG. 2 shows that component 178 can include timestamp generator 186, request processor 188, request forwarding system 190, and other items 192. Component 180 can include timestamp generator 194, request processor 196, request forwarding system 198, and other items 200. Output component 182 can include timestamp generator 202, request processor 204, index entry output system 206, indexing latency output system 208, and other items 210. Search index 118 can include a plurality of different index entries 212-214, and any of a wide variety of other items 216. Latency processing system 124 can include one or more processors or servers 218, data store 220, dashboard system 222, action trigger generator 224, and other items 226.

As shown in FIG. 2, data content store 132 can include content items 158 which may be documents or other content items that are generated and/or modified by users 104-106 or workflows within or external to content computing system 102. Metadata 160 can include a wide variety of different types of metadata corresponding to the content items 158, such as the author, dates when the content items were generated and modified, distribution lists, permissions, etc.

In order for index request system 140 to generate an index request 112, change detection system 138 detects when content is modified in content computing system 102. The modified content may be newly generated content, revised content, or other modifications to content in data content store 132. In some examples, the modifications are not indexed. For instance, where the content is private or non-sharable content, then the content and modifications to that content will not be indexed in search index 118. Thus, change detection system 138 can be configured to detect modifications (generation or changes) to content that is to be indexed and provide an output to trigger detector 144. Trigger detector 144 can then generate an output to request generator 146 to generate an index request 112. Request generator 146 then generates index request 112 based upon the detected modification. For instance, request generator 146 can generate an identifier 163 identifying request 112 as well as request content 164 indicative of the modified content. Request generator 146 can use property generator 148 to identify properties 166 corresponding to the modification that can be included in index request 112. The properties 166 can be any of a wide variety of different properties that may be useful to latency processing system 124 or other items in architecture 100. Some examples of properties 166 are discussed elsewhere herein. Priority generator 150 can also generate a priority 168 corresponding to the operation that generated the content modification. For instance, the priority may be assigned by content computing system 102 so that high priority operations or modifications are indexed more quickly than lower priority modifications or content. By way of example, if the operation that modified the content is to publish a new content item (e.g., a new document) in content data store 132, then priority generator 150 may assign a high priority to that operation or modification because it may be desirable to have such modifications indexed into search index 118 more quickly. However, if the modification is a workflow-initiated modification which changes some metadata 160 corresponding to a content item 158, then that modification may have a lower priority as it will not significantly affect the precision and recall performance of search system 120 with respect to more important (or higher priority) modifications.

Timestamp generator 152 generates a timestamp 170 indicating when the modification was made. The timestamp may be generated based on when a content item was saved to content data store 132 (as indicated in metadata 160) or in other ways. Request output system 154 then outputs the index request 112 to search index ingestion pipeline 114.

Each of the components 178, 180, 182 in search index ingestion pipeline 114 may have a different request processor (or a request processor that is programmed differently) 188, 196, 204, that processes the index request 112 in different ways. Each request processor 188, 196, and 204 may, for instance, perform different operations based upon the index request 112 in order to generate the index entry 116. For instance, one of the different request processors may apply custom search schema to generate index entry 116. Another request processor may create a secondary copy of the modified content to support the search index 118. Each request processor 188, 196, and 204 may perform other operations as well. Thus, when a component 178 receives the index request 112, timestamp generator 186 first generates a timestamp indicating when the index request 112 was received (e.g., placed in the queue of) component 178. Request processor 188 retrieves each index request 112 from the queue and performs the desired request processing on that request. Request forwarding system 190 then forwards the result of the request processing and/or the timestamps 170 and the timestamp generated by timestamp generator 186, along with properties 166 and priority 168 (and other information from index request 112) to the next component 180 in the search index ingestion pipeline 114. Each of the components in pipeline 114 generates a corresponding timestamp, performs its corresponding request processing, and forwards all of the aggregated timestamps, properties, priority, and other content to the next subsequent component in the pipeline 114.

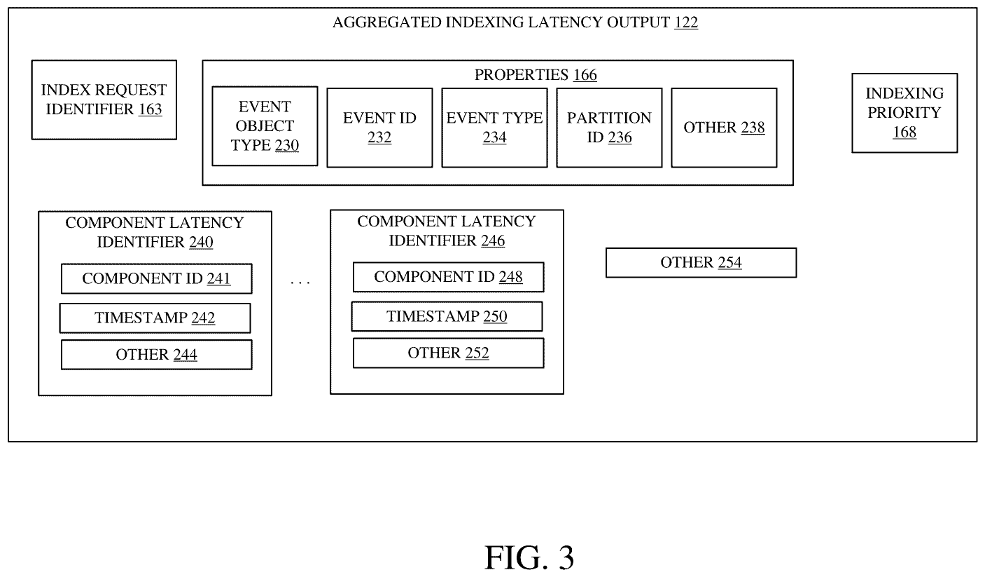

Eventually, output component 182 receives the index request 112 (and/or the results of processing by the previous components 178-180 in the pipeline 114), the timestamps, properties, priority, etc., and timestamp generator 202 generates a timestamp indicating when that information is received at output component 182. Request processor 204 performs any additional processing to generate index entry 116, and index entry output system 206 outputs the index entry 116 for incorporation (e.g., storage) in search index 118. Indexing latency output system 208 outputs the aggregated indexing latency output 122. Output 122 can include a wide variety of information, some of which is illustrated in the block diagram shown in FIG. 3.

FIG. 3 shows a block diagram of one example of aggregated indexing latency output 122. Output 122 can include the index request identifier 163 which may be a unique identifier corresponding to index request 112. Output 122 can also include properties 166. In the example shown in FIG. 3, properties 166 can include an event object type property 230, an event identifier property 232, event type property 234, partition ID property 236, and any of a wide variety of other properties 238. Output 122 can include indexing priority 168, and component latency identifiers 240, 246 which include the timestamps generated by each of the components 178-182. For instance, output 126 can include a plurality of component latency identifiers 240, 246, each of which identifies the particular corresponding component 178, 180, 182, as well as the timestamp generated by the corresponding component for this particular index request 112. Component latency identifier 240 thus includes component ID 241, time stamp 242, and it can include other information 244 as well. Component latency identifier 246 includes component ID 248, timestamp 250, and other items 252. Output 122 can also include other items 254.

When aggregated indexing latency output 122 is provided to latency processing system 124, processors/servers 218 can perform analysis on the latency data and generate an output through dashboard system 222. Dashboard system 222 can thus use the properties 166 to identify the different types of modification operations and the latency corresponding to those operations, as well as the latency corresponding to each component in search index ingestion pipeline 114, and a wide variety of other information. Action trigger generator 224 can generate other action signals as well, such as alerts, or suggested or automated revisions to the request processors in each of the components 178, 180, 182 if those components are outside of a threshold latency value, for instance. Action trigger generator 224 can generate a wide variety of other action signals as well.

A number of the example properties 166 will now be discussed. As shown in FIG. 3, the properties 166 can include event object type property 230. This property may be a parameter defined by the content computing system 102 and can differentiate between index operations that are to be performed for different kinds of objects. For instance, in the case of a database system, this parameter may facilitate the distinction between actions performed on individual content items 158 versus actions performed on aggregations of content items (such as folders) within the system. This differentiation enables a more fine-grained analysis of the indexing operations which can provide information indicative of the effectiveness and timeliness of the search index updates for different types of objects within the content computing system 102.

Properties 166 can also include the event ID property 232 which may be a parameter tied to a single user action, such as renaming a collection of documents. Such an action may trigger reindexing of all items in that collection and all of those reindexing operations would then share the same event ID. This parameter allows latency processing system 124 to track and correlate indexing operations associated with specific user actions. This enhances the ability to understand the impact of user interactions on the latency introduced by the search index ingestion pipeline 114, and to modify components 178-182 to better deal with such interactions.

Properties 166 may include the event type property 234 which may be a parameter describing the type of update generated in content computing system 202 that triggered the indexing operation. Some types of updates may include updating permissions for a content item 158, sharing a content item 158, creating a new content item 158, etc. This parameter provides context for the nature of changes in the content computing system 102 that trigger indexing operations, which allows for a more comprehensive understanding of the events that affect search index latency and facilitate more efficient operation of components 178-182. Such information can be used by latency processing system 124 to identify patterns and trends related to different types of update operations and for suggesting or generating reconfiguration operations to specific update types in order to improve the overall search index performance.

The properties 166 can include the partition ID property 236. The partition ID property 236 may be a parameter that provides information about the partitioning of the content computing system 102 which may enable a deeper understanding of the end-to-end latency for indexing items in a particular system 102. For instance, latency processing system 124 can identify latency information corresponding to indexing operations performed based on modifications to content in a specific partition in system 102. This enhances the ability of making targeted reconfigurations or optimizations and improvements to the components 178-182 in search index ingestion pipeline 114.

The indexing priority value 168 may be a parameter that is defined by content computing system 102 and which provides an indication of the importance of the indexing operation to the overall search experience for content items generated and modified by content computing system 102. Indexing priority value 168 allows for prioritization of indexing operations based upon their significance so that search index ingestion pipeline 114 can allocate appropriate resources and processing capabilities of the various components 178-182 based upon the indexing priority 168. This enables pipeline 114 to deploy resources to ensure that critical operations are processed more quickly, resulting in faster and more timely updates to the search index 118 for those operations. This increases the precision and recall performance of search system 120 by ensuring that important data updates are reflected in the search index 118 in a timely and effective manner. Because the components 178-182 receive indexing priority 168, each of those components can also allocate the usage of their resources to prioritize more important index operations over others.

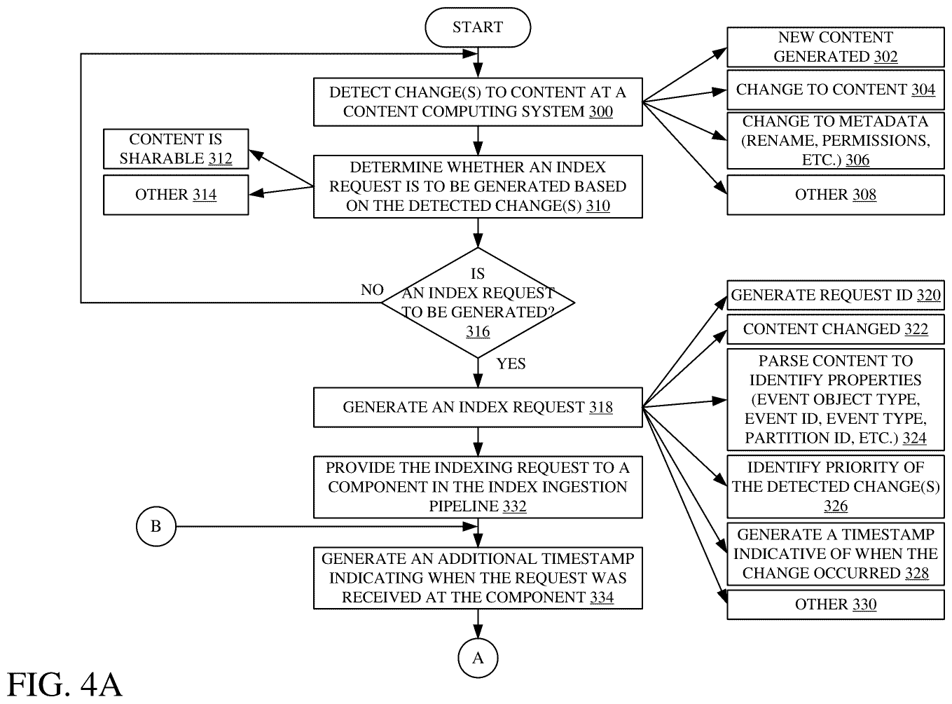

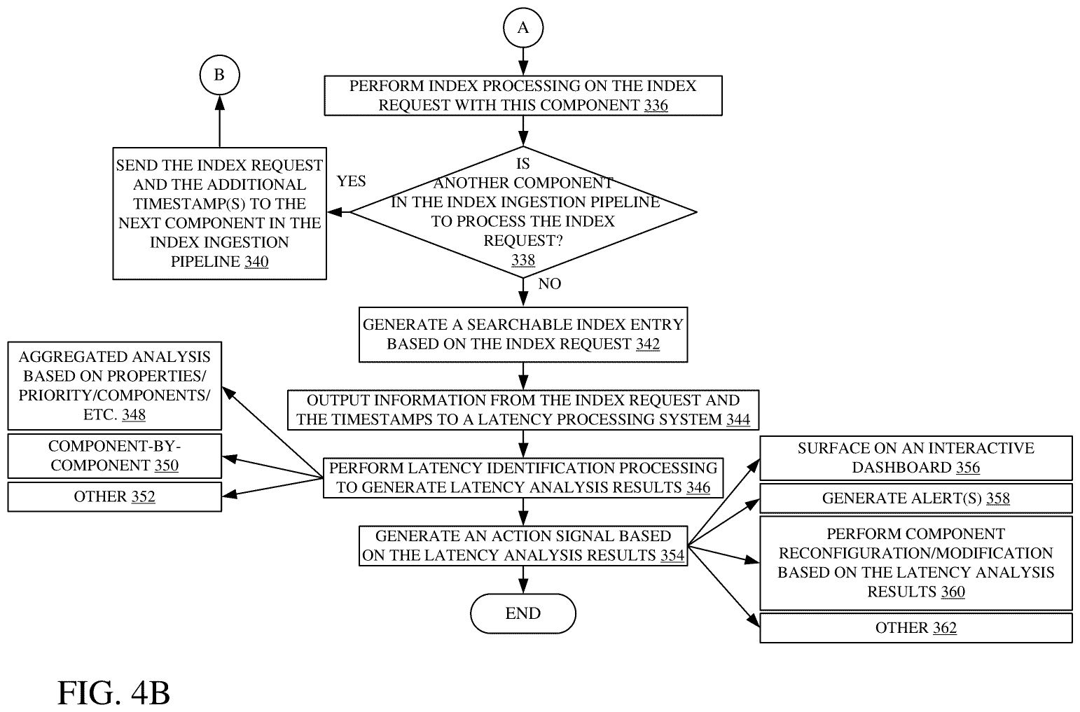

FIGS. 4A and 4B (collectively referred to herein as FIG. 4) show a flow diagram illustrating one example of the operation of computing system architecture 100 in generating index entries in search index 118 and in generating action signals based upon aggregated indexing latency output 122. It is first assumed that change detection system 138 detects a change to content in the content data store 132 in content computing system 102, as indicated by block 300 in the flow diagram of FIG. 4. The change can be that a new content item 158 is generated, as indicated by block 302, that a content item is changed or modified as indicated by block 304, that metadata 160 is changed (such as when content is renamed or permissions are changed, etc.) as indicated by block 306, or that any of a wide variety of other user-initiated or workflow-initiated, or other changes or modifications are detected, as indicated by block 308.

Change detection system 138 can then determine whether an index request 112 is to be generated based upon the detected change, as indicated by block 310 in the flow diagram of FIG. 4. For instance, change detection system 138 can also process the metadata 160 corresponding to the modified content to detect whether the change is being made to content that is sharable or is otherwise public, as indicated by block 312. If not, then no index entry will be generated in search index 118 for that item and index request 112 need not be generated. Change detection system 138 can determine whether an index request 112 is to be generated in any of a wide variety of other ways as well. If no index request 112 is to be generated, as determined at block 316, then processing reverts to block 300 where change detection system 138 waits for another content modification.

However, if, at block 316, change detection system 138 determines that an index request 112 should be generated for the content modification, then index request system 148 generates an index request 112, as indicated by block 318 in the flow diagram of FIG. 4. Trigger detector 144 detects a trigger that index request 112 is to be generated. The trigger may be, for instance, an input from change detection system 138 or another trigger.

Request generator 146 then generates a request identifier, as indicated by block 320 in the flow diagram of FIG. 4 and also incorporates request content 164, as indicated by block 322.

Property generator 148 can then parse the modified content or other information to identify properties 166. Parsing the content to identify properties is indicated by block 324 in the flow diagram of FIG. 4. The properties can include those discussed above with respect to FIG. 3 and/or other properties.

Priority generator 150 identifies the priority corresponding to the modification as indicated by block 326 in the flow diagram of FIG. 4. The priority may be set by content computing system 102, using rules or a dynamic model or in other ways.

Timestamp generator 152 also generates a timestamp indicating when the change or modification for which the index entry is being generated occurred, as indicated by block 328 in the flow diagram of FIG. 4. For instance, it may be that content generation/modification system 136 records the time when a modification is stored to content data store 132. The timestamp may be generated using that information or other timestamp information as well. Index request system 140 can perform other operations to generate index request 112 as well, as indicated by block 330 in the flow diagram of FIG. 4.

Request output system 154 then provides the index request 112 to a component (e.g., for the sake of the present discussion it will be assumed that component 178 processes the index request 112 first) in the search index ingestion pipeline 114, as indicated by block 332 in the flow diagram of FIG. 4. Component 178 uses timestamp generator 186 to generate another timestamp (in addition to timestamp 170) indicating when the index request 112 is received by component 178. Generating the additional timestamp is indicated by block 334 in the flow diagram of FIG. 4.

Request processor 188 performs index processing on the index request 112 that is provided to component 178. Performing the index request processing is indicated by block 336 in the flow diagram of FIG. 4. If another component (e.g., component 180) is downstream of component 178 in the index ingestion pipeline 114, then request forwarding system 190 determines that the index request 112 (along with the timestamp generated by timestamp generator 186) and any other information output by component 178 is to be forwarded to the next subsequent component 180 in index ingestion pipeline 114. Determining whether another component is to perform processing based upon the index request 112 is indicated by block 338 in the flow diagram of FIG. 4.

If so, then request forwarding system 190 sends any relevant information from index request 112, along with the timestamps (and properties 166 and indexing priority 168) to the next component 180 where processing reverts to block 334. Forwarding the index request 112 to the next component 180 is indicated by block 340. That component 180 then uses timestamp generator 194 to generate another timestamp indicating when the information was received at component 180. The request processing done by component 180 is performed by request processor 196, and request forwarding system 198 determines whether the request information and the additional timestamps should be forwarded to yet another component in index ingestion pipeline 114. Once the request reaches (and is processed by) output component 182, then index entry output system 206 generates the searchable index entry 116 based upon the index request 112 and based upon the processing results of all of the components 178-180 upstream of component 182 in the search index ingestion pipeline 114. Generating the searchable index entry 116 is indicated by block 342 in the flow diagram of FIG. 4.

Indexing latency output system 208 then outputs the aggregated indexing latency output 122 (such as identifier 163, the request content 164, properties 166, priority 168, timestamp 170, etc., along with the timestamps generated by the other components 178-182) to the latency processing system 124. Outputting the information is indicated by block 344 in the flow diagram of FIG. 4.

Latency processing system 124 performs latency processing to generate latency analysis results, as indicated by block 346. For instance, latency processing system 124 can perform latency analysis based upon the properties, priority, components, etc., as indicated by block 348. The analysis can be generated on a component-by-component basis, as indicated by block 350. A wide variety of other analyses can be generated in a wide variety of other ways as well, as indicated by block 352.

Action trigger generator 224 and dashboard system 222 can generate signals to trigger or perform actions in various ways, based upon the analysis results. Generating an action trigger based on the latency analysis results is indicated by block 354 in the flow diagram of FIG. 4. For instance, dashboard system 222 can surface (e.g., display or otherwise make available) an interactive dashboard as an interactive output 126 to the various component generation/configuration systems 128. Surfacing an interactive dashboard is indicated by block 356 in the flow diagram of FIG. 4.

By way of example, the interactive dashboard may provide information relative to each component 178-182 (such as how quickly the component processed different index requests-defined by the different properties 166, priorities 168, etc.) so that the information can be used to reconfigure, redesign or make other changes to each of the components 178-182 to improve the latency introduced by each component 178-182. This, in turn, increases the precision and recall performance of search system 120 because search index 118 is updated more quickly. Action trigger generator 224 can also generate alerts 358 so that the teams or other organizations responsible for each of the components 178-182 know very quickly when the component is exceeding a desired latency by a threshold amount, or that the component 178-182 is operating in another way that the team or organization should be alerted to.

In another example, action trigger generator 224 can generate an output to perform automatic reconfiguration of components 178-182 based upon the latency analysis results corresponding to each of the components. For instance, the automated reconfiguration steps can be to modify the allocation of resources in any of the components, or any of a wide variety of other reconfiguration steps. In yet another example, the reconfiguration steps may be output as suggestions which can be authorized by a user (e.g., a developer or engineer) at component generation/configuration systems 128. In that case, the suggested reconfiguration steps may be described to the user of system 128, along with a user interface actuator (such as a button, link, etc.) that the user of system 128 can actuate in order to have the reconfiguration steps automatically performed. Performing component reconfiguration or modification (manually, automatically, or semiautomatically) based upon the analysis results is indicated by block 360 in the flow diagram of FIG. 4. Latency processing system 124 can generate any of a wide variety of other action signals as well, as indicated by block 362. By automatically it is meant, in one example, that the operation is performed without further human involvement except, perhaps, to initiate or authorize the operation.

It can thus be seen that the present description describes a system which automatically detects and surfaces latency data corresponding to different components 178-182 in the search index ingestion pipeline 114. The latency data is also surfaced along with information from the index request 112 such as the properties of the request, the priority of the request, etc., so that the latency can be parsed according to the components, properties, and/or priority. This latency detection and aggregation can be used to improve the efficiency and speed of each of the components 178-182 in the search index ingestion pipeline 114 to index items more quickly into search index 118. The improvement thus results in an improvement in the precision and recall performance of search system 120.

It will be noted that the above discussion has described a variety of different systems, components, generators, and/or logic. It will be appreciated that such systems, components, generators, and/or logic can be comprised of hardware items (such as processors and associated memory, or other processing components, some of which are described below) that perform the functions associated with those systems, components, generators, and/or logic. In addition, the systems, components, generators, and/or logic can be comprised of software that is loaded into a memory and is subsequently executed by a processor or server, or other computing component, as described below. The systems, components, generators, and/or logic can also be comprised of different combinations of hardware, software, firmware, etc., some examples of which are described below. These are only some examples of different structures that can be used to form the systems, components, generators, and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

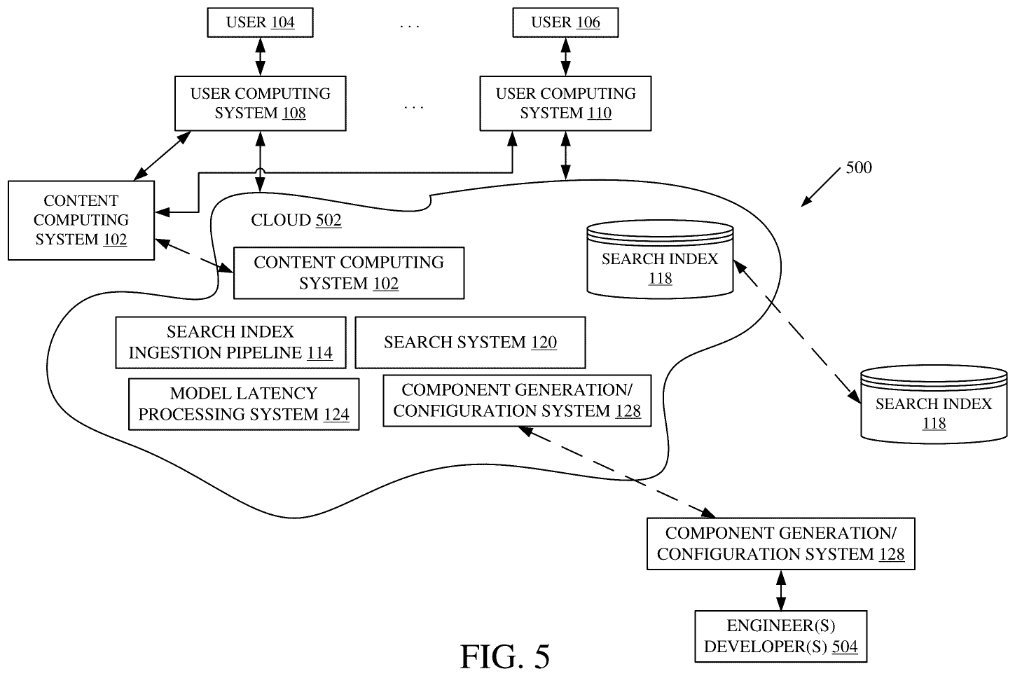

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that systems 102, 120, 124, and/or 128 can be located in cloud 502 (which can be public, private, or a combination where portions are public while others are private). Therefore, users 104-106 use user computing system 108-110 to access those systems through cloud 502. Engineers/developers 504 can also access system 128 directly or through cloud 502.

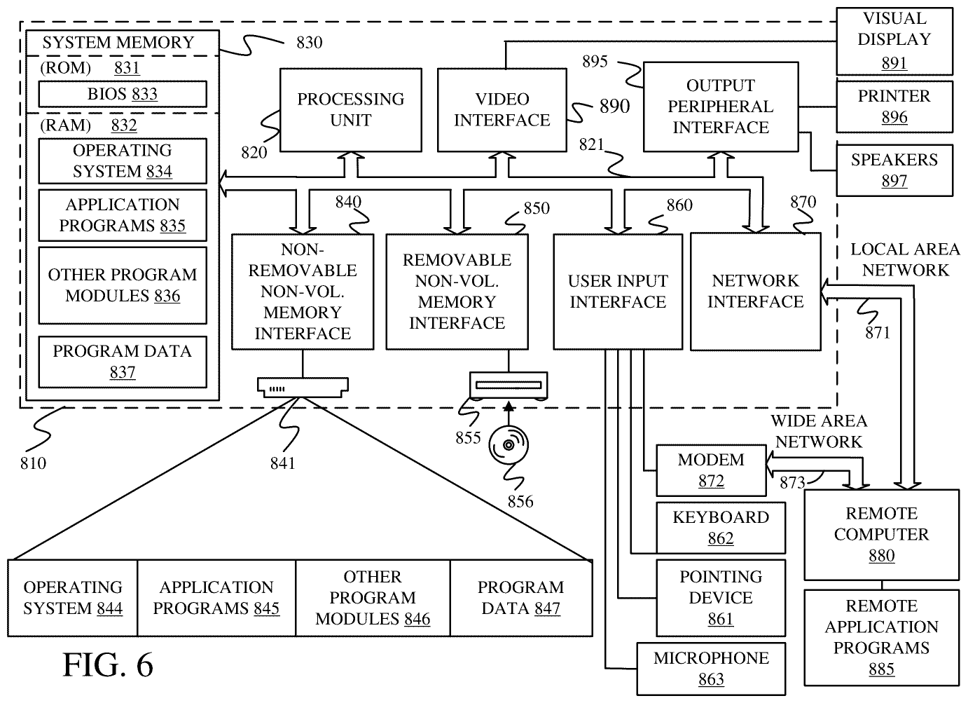

FIG. 5 also depicts another embodiment of a cloud architecture. FIG. 6 shows that it is also contemplated that some elements of computing system architecture 100 can be disposed in cloud 502 while others are not. By way of example, data store 118 can be disposed outside of cloud 502, and accessed through cloud 502. In another example, systems 102, 128 (or other items) can be outside of cloud 502. Regardless of where the items are located, the items can be accessed directly through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

FIG. 6 is one example of a computing environment in which architecture 100, or parts of it, (for example) can be deployed. With reference to FIG. 6, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 6.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 6 illustrates operating system 834, application programs 835, other program modules 836, and program data 837.

The computer 810 may also include other removable/non-removable volatile/nonvolatile computer storage media. By way of example only, FIG. 6 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 6, provide storage of computer readable instructions, data structures, program modules and other data for the computer 810. In FIG. 6, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 6 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 6 illustrates remote application programs 885 as residing on remote computer 880. It will be appreciated that the network connections shown are examples and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:
generating an index request to perform an indexing operation based on a change to content in a content computing system;
providing the index request to a first processing component in an index ingestion pipeline;
performing a first processing operation at the first processing component;
generating a first processing timestamp at the first processing component, the first processing timestamp indicating a time when the index request is received at the first processing component;
providing the first processing timestamp and request data from the index request to a subsequent processing component in the index ingestion pipeline;
performing a subsequent processing operation at the subsequent processing component;
generating a subsequent processing timestamp at the subsequent processing component, the subsequent processing timestamp indicating a time when the request data from the index request is received at the subsequent processing component; and
generating an action signal based on the first timestamp and the subsequent timestamp.

Example 2 is the computer implemented method of any or all previous examples wherein generating an action signal comprises:
generating a latency output indicative of a latency in processing the index request at the first processing component and a latency in processing the index request at the subsequent processing component.

Example 3 is the computer implemented method of any or all previous examples wherein generating an index request comprises:
detecting a set of properties of the change to the content in the content computing system; and
generating the index request to include the set of properties.

Example 4 is the computer implemented method of any or all previous examples wherein detecting a set of properties comprises:
detecting an event object type property indicative of whether the change to the content is based on an action performed on an individual content item or an action performed on a set of a plurality of content items.

Example 5 is the computer implemented method of any or all previous examples wherein detecting a set of properties comprises:
detecting an event identifier property identifying an action that resulted in the change to the content.

Example 6 is the computer implemented method of any or all previous examples wherein detecting a set of properties comprises:
detecting an event type property indicative of a type of action that triggered generating the index request to perform the indexing operation.

Example 7 is the computer implemented method of any or all previous examples wherein detecting a set of properties comprises:
detecting a priority property indicative of a priority of the indexing operation.

Example 8 is the computer implemented method of any or all previous examples wherein detecting a set of properties comprises:
detecting a partition identification property identifying a location in the content computing system where the change to the content occurred.

Example 9 is the computer implemented method of any or all previous examples wherein generating an index request comprises:
detecting an initial timestamp indicative of a time when the detected change was made; and
generating the index request including the initial timestamp.

Example 10 is the computer implemented method of any or all previous examples wherein generating an action signal comprises:
generating a reconfiguration step based on the latency output, the reconfiguration step identifying a step for reconfiguring a selected component, of the first component and the subsequent component, is to be reconfigured to improve latency in the selected component.

Example 11 is the computer implemented method of any or all previous examples wherein generating an action signal comprises:
generating an alert signal indicating that a component, of the first component and the subsequent component, has a latency that is a threshold value above a desired latency value.

Example 12 is an index ingestion computing system generating an index entry based on a change in content in a content computer system, the index ingestion computing system comprising:
at least one processor;
a first processing component, implemented by the at least one processor, configured to receive an index request to perform a first processing operation based on the change in content, the first processing component including a first timestamp generator generating a first timestamp indicative of a time when the first processing component received the index request; and
an output processing component, implemented by the at least one processor, configured to receive index information from the index request, to perform an output processing operation based on the change in content to generate the index entry for entry in a search index, the output processing component including an output timestamp generator generating an output timestamp indicative of a time when the output processing component received the index information, the output processing component including an indexing latency output component generating an indexing latency output indicative of a first latency introduced by the first processing component and an output latency introduced by the output processing component.

Example 13 is the index ingestion computing system of any or all previous examples wherein the index request includes a set of properties corresponding to the change in content and wherein the first processing component comprises:
a request forwarding system configured to forward the first timestamp and the set of properties to the output component.

Example 14 is the index ingestion computing system of any or all previous examples wherein the indexing latency output component is configured to include the set of properties in the indexing latency output.

Example 15 is the index ingestion computing system of any or all previous examples and further comprising:
an intermediate processing component between the first processing component and the output processing component in the index ingestion computing system, the intermediate processing component being configured to receive index information from the index request and including a request processor configured to perform an intermediate processing operation based on the index information received from the index request.

Example 16 is the index ingestion computing system of any or all previous examples wherein the intermediate processing component comprises:
an intermediate timestamp generator configured to generate an intermediate timestamp indicative of a time when the index information is received at the intermediate processing component.

Example 17 is the index ingestion computing system of any or all previous examples wherein the intermediate processing component comprises:
an intermediate request forwarding component configured to forward the first timestamp, the intermediate timestamp and the set of properties to the output processing component.

Example 18 is a computer system, comprising:
an index request generator configured to identify characteristics of a detected change in content on a content store and generate an index request identifying the detected change and the characteristics;
a pipeline of a plurality of different processing components, each configured to perform a different index generation processing step to generate an index entry for the detected change in content; and
a latency detector configured to detect a latency introduced by each of the different processing components in the pipeline.

Example 19 is the computer system of any or all previous examples wherein the pipeline includes an output processing component and wherein the pipeline is configured to pass the characteristics of the detected change to the output processing component.

Example 20 is the computer system of any or all previous examples wherein the output component is configured to generate a latency output including the detected latency introduced by each of the different processing components in the pipeline and the characteristics of the detected change.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
generating an index request to perform an indexing operation based on a change to content in a content computing system;
providing the index request to a first processing component in an index ingestion pipeline;
performing a first processing operation at the first processing component;
generating a first processing timestamp at the first processing component, the first processing timestamp indicating a time when the index request is received at the first processing component;
providing the first processing timestamp and request data from the index request to a subsequent processing component in the index ingestion pipeline;
performing a subsequent processing operation at the subsequent processing component;
generating a subsequent processing timestamp at the subsequent processing component, the subsequent processing timestamp indicating a time when the request data from the index request is received at the subsequent processing component; and
generating an action signal based on the first timestamp and the subsequent timestamp.

2. The computer implemented method of claim 1 wherein generating an action signal comprises:
generating a latency output indicative of a latency in processing the index request at the first processing component and a latency in processing the index request at the subsequent processing component.

3. The computer implemented method of claim 1 wherein generating an index request comprises:
detecting a set of properties of the change to the content in the content computing system; and
generating the index request to include the set of properties.

4. The computer implemented method of claim 3 wherein detecting a set of properties comprises:
detecting an event object type property indicative of whether the change to the content is based on an action performed on an individual content item or an action performed on a set of a plurality of content items.

5. The computer implemented method of claim 3 wherein detecting a set of properties comprises:
detecting an event identifier property identifying an action that resulted in the change to the content.

6. The computer implemented method of claim 3 wherein detecting a set of properties comprises:
detecting an event type property indicative of a type of action that triggered generating the index request to perform the indexing operation.

7. The computer implemented method of claim 3 wherein detecting a set of properties comprises:
detecting a priority property indicative of a priority of the indexing operation.

8. The computer implemented method of claim 3 wherein detecting a set of properties comprises:
detecting a partition identification property identifying a location in the content computing system where the change to the content occurred.

9. The computer implemented method of claim 3 wherein generating an index request comprises:
detecting an initial timestamp indicative of a time when the detected change was made; and
generating the index request including the initial timestamp.

10. The computer implemented method of claim 2 wherein generating an action signal comprises:
generating a reconfiguration step based on the latency output, the reconfiguration step identifying a step for reconfiguring a selected component, of the first component and the subsequent component, is to be reconfigured to improve latency in the selected component.

11. The computer implemented method of claim 2 wherein generating an action signal comprises:
generating an alert signal indicating that a component, of the first component and the subsequent component, has a latency that is a threshold value above a desired latency value.

12. An index ingestion computing system generating an index entry based on a change in content in a content computer system, the index ingestion computing system comprising:
at least one processor;
a first processing component, implemented by the at least one processor, configured to receive an index request to perform a first processing operation based on the change in content, the first processing component including a first timestamp generator generating a first timestamp indicative of a time when the first processing component received the index request; and
an output processing component, implemented by the at least one processor, configured to receive index information from the index request, to perform an output processing operation based on the change in content to generate the index entry for entry in a search index, the output processing component including an output timestamp generator generating an output timestamp indicative of a time when the output processing component received the index information, the output processing component including an indexing latency output component generating an indexing latency output indicative of a first latency introduced by the first processing component and an output latency introduced by the output processing component.

13. The index ingestion computing system of claim 12 wherein the index request includes a set of properties corresponding to the change in content and wherein the first processing component comprises:
a request forwarding system configured to forward the first timestamp and the set of properties to the output component.

14. The index ingestion computing system of claim 13 wherein the indexing latency output component is configured to include the set of properties in the indexing latency output.

15. The index ingestion computing system of claim 14 and further comprising:
an intermediate processing component between the first processing component and the output processing component in the index ingestion computing system, the intermediate processing component being configured to receive index information from the index request and including a request processor configured to perform an intermediate processing operation based on the index information received from the index request.

16. The index ingestion computing system of claim 15 wherein the intermediate processing component comprises:
an intermediate timestamp generator configured to generate an intermediate timestamp indicative of a time when the index information is received at the intermediate processing component.

17. The index ingestion computing system of claim 16 wherein the intermediate processing component comprises:
an intermediate request forwarding component configured to forward the first timestamp, the intermediate timestamp and the set of properties to the output processing component.

18. A computer system, comprising:
an index request generator configured to identify characteristics of a detected change in content on a content store and generate an index request identifying the detected change and the characteristics;
a pipeline of a plurality of different processing components, each configured to perform a different index generation processing step to generate an index entry for the detected change in content; and
a latency detector configured to detect a latency introduced by each of the different processing components in the pipeline.

19. The computer system of claim 18 wherein the pipeline includes an output processing component and wherein the pipeline is configured to pass the characteristics of the detected change to the output processing component.

20. The computer system of claim 19 wherein the output component is configured to generate a latency output including the detected latency introduced by each of the different processing components in the pipeline and the characteristics of the detected change.
